(19) United States
(12) Patent Application Publication
(10) Pub. No.: US 2002/0157462 A1
(43) Pub. Date: Oct. 31, 2002

(54) Tire pressure monitoring system

(76) Inventors: Lewis Lee Knox, Rialto, CA (US); James Allen Roberts, Bloomington, CA (US)

Correspondence Address: OUR PAL ASIJA, ASIJA HOUSE, 7 WOONSOCKET AVENUE, SHELTON, CT, 06484-5536, US

(21) Appl. No.: 09/753,391

(22) Filed: Apr. 27, 2001

(51) Int. Cl. B60C 23/02

(52) U.S. Cl. 73/146.3

(57) ABSTRACT

A system for measuring the pressure in a rotating tire and transmitting the information via magnetic pulses to a sensor pickup located near the tire, but on a non-rotating part of the vehicle, for transmittal via wire to a micro controller for conversion to air pressure units and display.

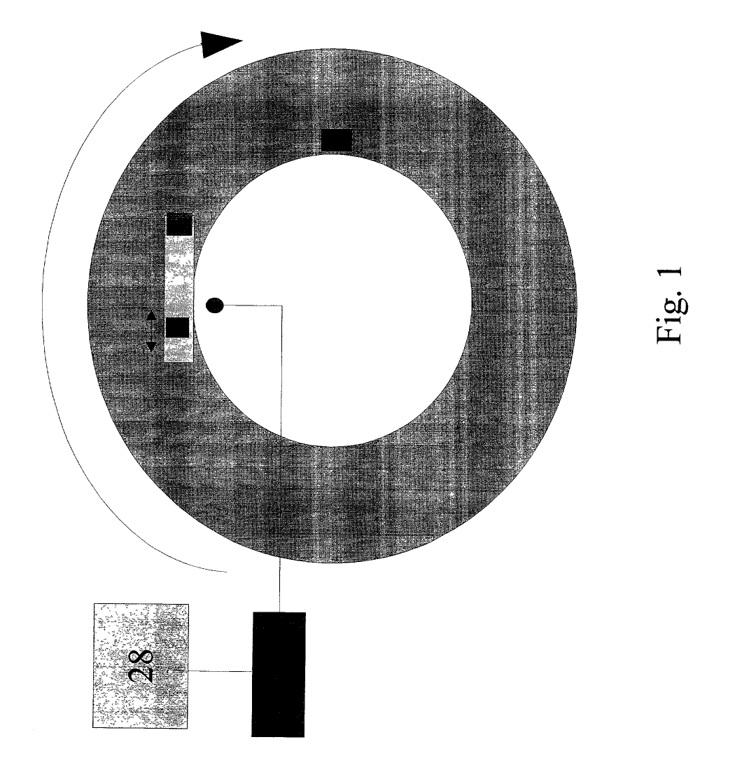

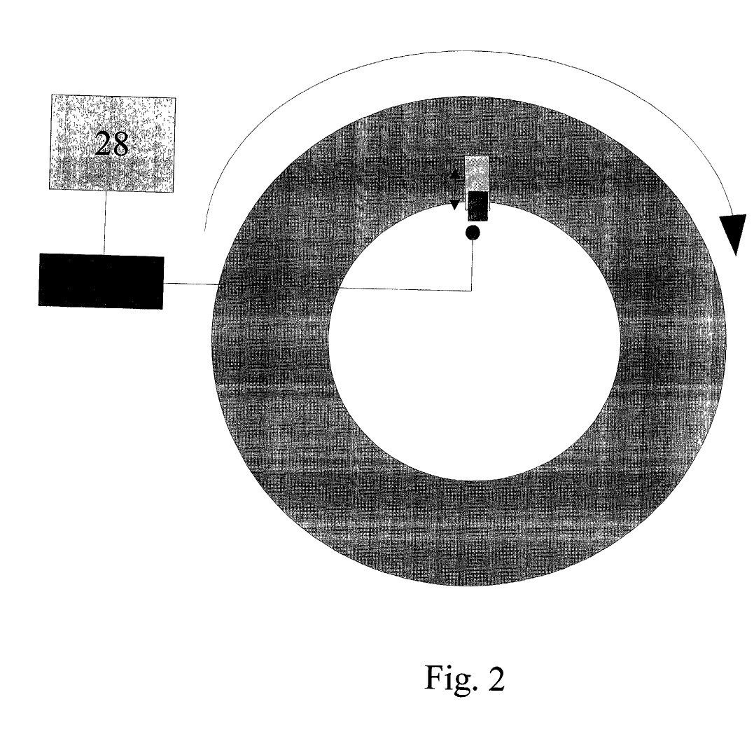

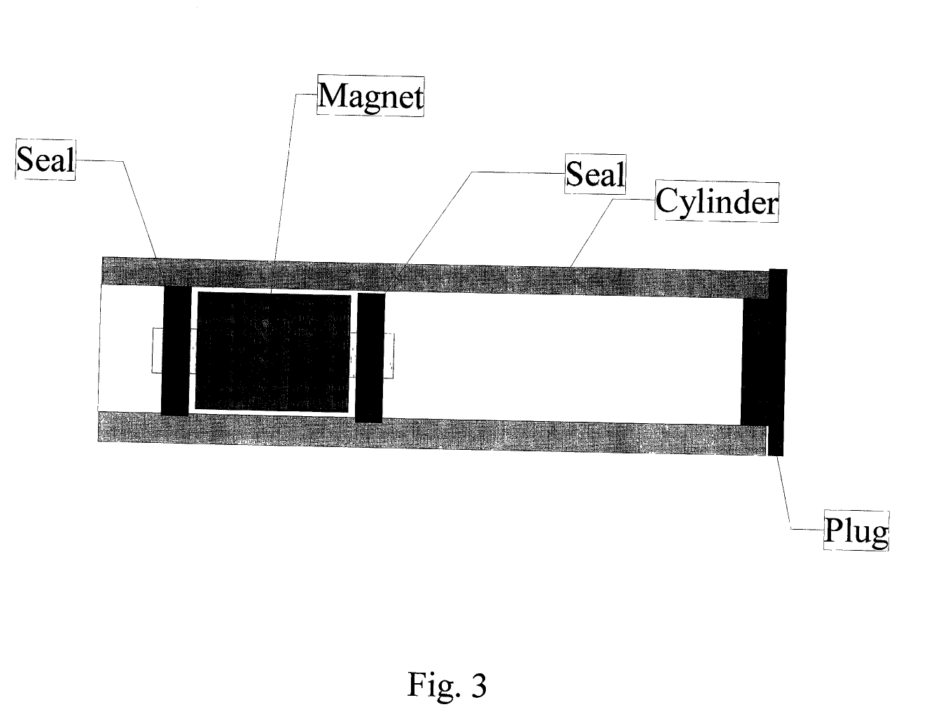

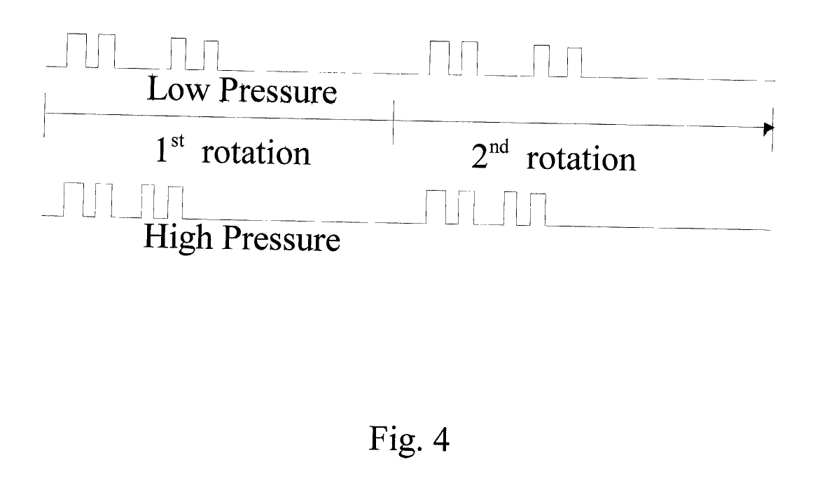

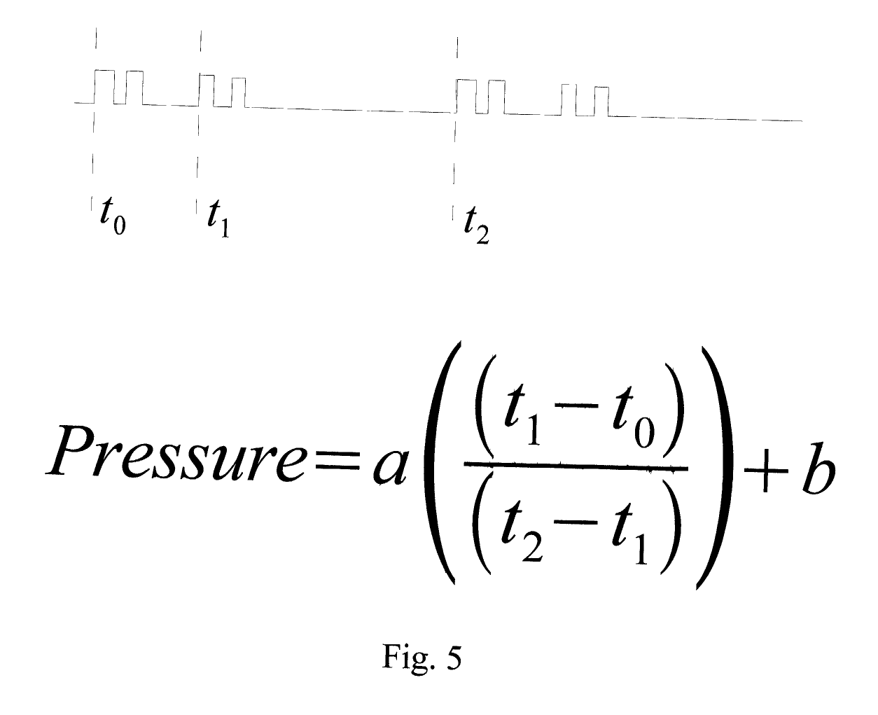

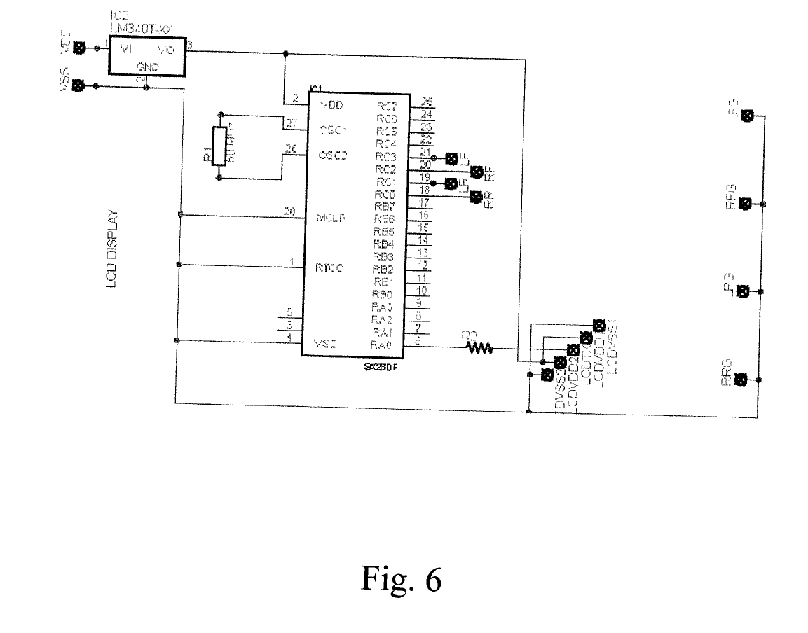

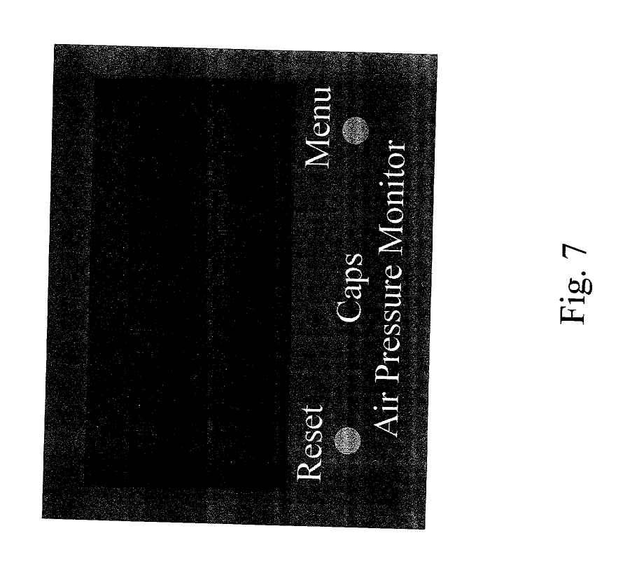

### SUMMARY OF THE INVENTION

### BACKGROUND

1. The present invention relates to a system for the transmission of air pressure information from inside a rotating tire to the non-rotating portion of a vehicle, from whence it can be displayed.

2. Such a system must employ a method of wireless transmission from the rotating to the non-rotating components.

3. Prior art involves the use of slip rings or radio transmission to obtain the desired effect.

### SUMMARY OF THE INVENTION

4. Starting out from prior art, the air pressure can be measured by the displacement of a cylinder in an air piston.

5. By attaching a magnet to the piston in the air cylinder a magnetic field will be generated around the piston.

6. To allow computation a reference is required. For a vertically aligned piston this can be the center of the magnetic field, and for a horizontally aligned piston a separate reference magnet.

6. The displacement of the piston can be sensed by one of several pickups sensitive to magnetic fields (reed switch, hall effect switch, . . . etc).

7. The sensor pickup transducer changes the magnetic field into an electrical stream of digital pulses. A subset of the pulses is associated with the pistons magnet and another subset with the reference magnet.

8. By timing the pulses we can compute the angular displacement from the piston to reference. The higher the resolution of the timer, the more accurate the reading.

9. By knowing the radius to the piston we can compute the linear displacement of the piston given the angular displacement.

10. The air pressure is proportional to the linear displacement.

11. Once the air pressure is computed it may displayed using anyone of several computer driven display technologies (CRT, LED, LCD, . . . etc).

I claim:

1. A sensor for measuring the air pressure in a rotating tire on a moving vehicle which produces a series of magnetic pulses which can be processed and displayed as tire air pressure.
